(19) United States
(12) Patent Application Publication
(10) Pub. No.: US 2023/0419365 A1
(43) Pub. Date: Dec. 28, 2023

(54) ON-DEMAND ADVERTISEMENT SYSTEM

(71) Applicant: Charles Isgar, Scottsdale, AZ (US)

(72) Inventor: Charles Isgar, Scottsdale, AZ (US)

(21) Appl. No.: 18/461,797

(22) Filed: Sep. 6, 2023

Related U.S. Application Data
(63) Continuation of application No. 17/028,654, filed on Sep. 22, 2020, now abandoned.
Application No. 17/028,654 is a continuation-in-part of application No. 17/017,572, filed on Sep. 10, 2020, now abandoned.

(51) Int. Cl. G06Q 30/0251; G06Q 30/0273; H04W 4/23; H04W 4/021; H04W 4/024; G06Q 10/02

(52) U.S. Cl. CPC G06Q 30/0261; G06Q 30/0267; G06Q 30/0273; H04W 4/23; H04W 4/021; H04W 4/024; G06Q 10/02

(57) ABSTRACT

An on-demand portable advertisement system is provided. The system includes an advertisement device, a user computing device coupled to the advertisement device, and a server. The advertisement device, user computing device and server operate together in order to provide an assigned/selected location based direct advertising with advertisement devices that are screens to display advertising content based on the location of the sign. The server operates to provide the content based on the location of the advertisement device and the user computing device operates to communicate between the advertisement device and the server in order to effect the display of the advertisement content on the advertisement device while in an advertisement area.

### CROSS REFERENCE TO RELATED APPLICATION[S]

This application is a continuation of U.S. patent application entitled “ON-DEMAND ADVERTISEMENT SYSTEM,” Ser. No. 17/028,654, filed Sep. 22, 2020, which is a continuation-in-part of the earlier U.S. patent application entitled “FACE MASK WITH EMBEDDED TECHNOLOGY,” Ser. No. 17/017,572, filed Sep. 10, 2020, the disclosures of which are hereby incorporated entirely herein by reference.

### BACKGROUND OF THE INVENTION

### Technical Field

This invention relates generally to an advertisement system, and more particularly to an on-demand advertisement system that includes a portable digital sign configured to display advertisements based on geo-location of the digital sign.

### State of the Art

A form of direct advertisement to groups of people in certain locations or traveling certain routes is the use of signs held by individuals. This is often seen as an arrow sign directing people to a particular business that pays the individual to stand on the street, corner or the like with the sign and attempting to catch the attention of individuals passing by to direct them to the business. The current businesses provide the individuals with a sign that is static and pays the individual to hold the sign. Often these signs are flipped or otherwise utilized to draw attention to the advertisement. These systems of direct advertisement are limited in their ability to only have a static advertisement that cannot change once printed, require the business to perform all of the effort creating news signs for every single advertisement and throwing out old signs and redistributing signs to limited locations, to obtain and maintain the signage to be used and to hire individuals to present the advertisement sign to the public. There is a not a system that can centralize the sign advertisements by allowing businesses to sign up for use of such as system and the system deploying individuals to various locations to advertise for the company. There does not exist a system where businesses can provide the ad content and change the ad content as desired in order to update the advertisement signage to be held.

Accordingly, there is a need for an improved on-demand advertisement system.

### DISCLOSURE OF THE INVENTION

The present invention relates to an on-demand advertisement system that includes a portable digital sign configured to on demand display advertisements based on geo-location of the digital sign. The system operates to provide a self-deployed operators within a general geographic region to advertise at a plurality of advertisement area locations within the general geographic region and allows the self-deployed operators to determine the time allocations of their choosing with use a modern-day application of technology cooperating as a system to provide on-demand advertisements in the advertisement area locations.

An embodiment includes an on-demand advertisement system comprising: an advertisement device; a user computing device coupled to the advertisement device; and a server having a memory, wherein the user computing device is coupled to the server through a connection established by an app operating on the user computing device, and wherein the server is programmed to: receive a signal from the user computing device that an advertisement device is ready for advertising in response to the user computing device accessing the system; automatically process the signal and send for display on the user computing device advertisement data stored in the server, including available advertisement locations and pay rate for each advertisement location; receive a signal that includes a location selection from the user computing device and automatically process the location selection; send a notification to the user computing device that the location is reserved and directions from a location of the user computing device to the reserved location; receive a signal from the user computing device that the user computing device and the advertisement device are at the reserved location; and send advertisement content to the user computing device, wherein the user computing device sends the advertisement content to the advertisement device for display.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 a diagrammatic view of an on-demand advertisement system according to an embodiment;

FIG. 2 is a view of a programmed steps of a server of the on-demand advertisement system according to an embodiment;

FIG. 3 is a view of a user computing device operating an on-demand advertisement app of an on-demand advertisement system to start advertisement session in accordance with an embodiment;

FIG. 4 is a view of a user computing device operating the on-demand advertisement app of the on-demand advertisement system that depicts a map with advertisement locations available in accordance with an embodiment;

FIG. 5 is a view of a user computing device operating the on-demand advertisement app of the on-demand advertisement system that depicts a map with the reserved location and navigation to the reserved location in accordance with an embodiment;

FIG. 6 is a view of a user computing device operating an on-demand advertisement app of an on-demand advertisement system to send advertisement content to the advertisement device in accordance with an embodiment;

FIG. 7 is a perspective view of a user utilizing an advertisement device of the on-demand advertisement system in accordance with an embodiment;

FIG. 8 is a close-up perspective view of a user utilizing an advertisement device of the on-demand advertisement system in accordance with an embodiment;

FIG. 9 is a view of a user utilizing an advertisement device of the on-demand advertisement system in accordance with an embodiment;

FIG. 10 is a view of a user utilizing an advertisement device with a shoulder harness of the on-demand advertisement system in accordance with an embodiment;

FIG. 11 is a view of a user utilizing an advertisement device on wheels of the on-demand advertisement system in accordance with an embodiment;

FIG. 12 is a view of a user computing device operating the on-demand advertisement app of the on-demand advertisement system that depicts a map with advertisement locations available in accordance with an embodiment;

FIG. 13 is a view of a user computing device operating the on-demand advertisement app of the on-demand advertisement system that depicts a map with advertisement locations available in accordance with an embodiment;

FIG. 14 is a view of a user computing device operating an on-demand advertisement app of an on-demand advertisement system displaying weekly earnings in accordance with an embodiment;

FIG. 15 is a view of a user utilizing an advertisement device of the on-demand advertisement system in accordance with an embodiment;

FIG. 16 is a view of a user computing device operating the on-demand advertisement app of the on-demand advertisement system that depicts a map with advertisement locations available in accordance with an embodiment;

FIG. 17 is a view of a programmed steps of a server of the on-demand advertisement system according to an embodiment;

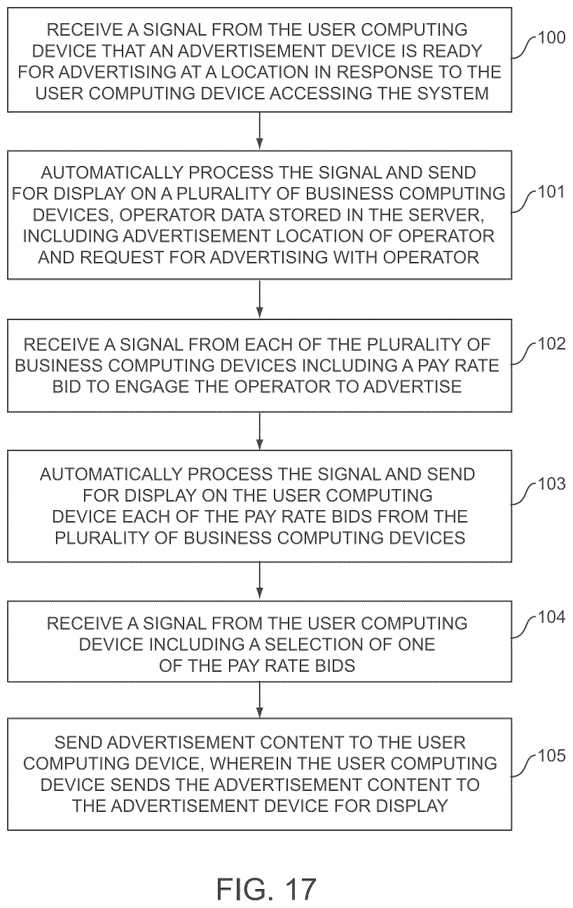

FIG. 18 is a perspective view of a user utilizing an advertisement device of the on-demand advertisement system in accordance with an embodiment

FIG. 19 is a view of a user computing device operating an on-demand advertisement app of an on-demand advertisement system to start advertisement session in accordance with an embodiment;

FIG. 20 is a view of a user computing device operating the on-demand advertisement app of the on-demand advertisement system that depicts a map with nearby businesses to the operator's advertisement locations available in accordance with an embodiment;

FIG. 21 is a view of a business computing device operating the on-demand advertisement app of the on-demand advertisement system that depicts a map with the operator location and option to send a pay rate bid to hire the operator to advertise in the operator's location in accordance with an embodiment;

FIG. 22 is a view of a user computing device operating an on-demand advertisement app of an on-demand advertisement system to view and select a pay rate bid from nearby businesses in accordance with an embodiment;

FIG. 23 is a view of a user computing device operating an on-demand advertisement app of an on-demand advertisement system to send advertisement content to the advertisement device in accordance with an embodiment; and

FIG. 24 is a front view of a user utilizing an advertisement device of the on-demand advertisement system in accordance with an embodiment.

### DETAILED DESCRIPTION OF EMBODIMENTS OF THE INVENTION

As discussed above, embodiments of the present invention relate to an on-demand advertisement system that includes a digital sign configured to display advertisements based on geo-location of the digital sign. The system may include the use of a mobile application or even a web app operating on a user computing device that may be a mobile computing device like a smartphone, a tablet, a wearable, and the like. The system may also include the use of programmed instructions operating on a server and communicating with the user computing device in order to provide functionality of the system.

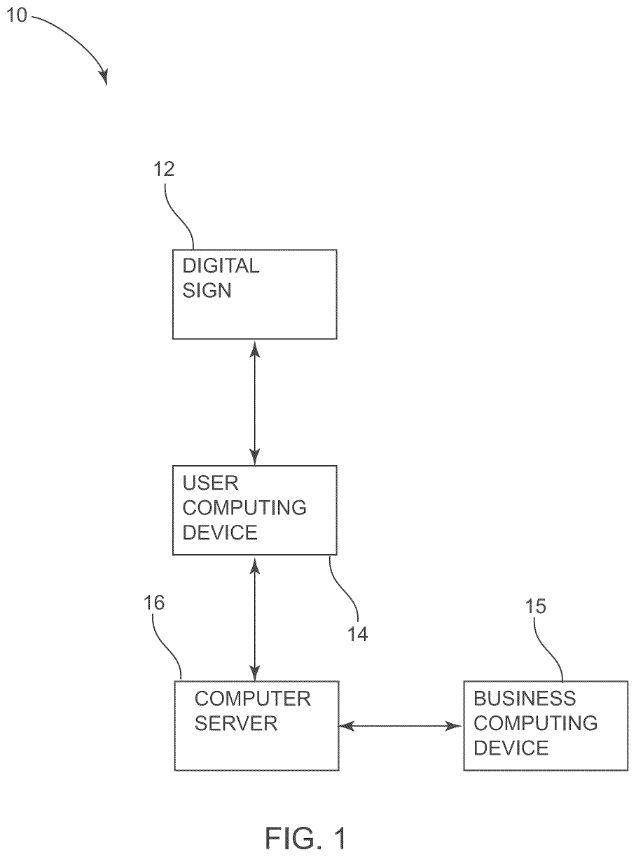

Referring to the drawings, FIG. 1 depicts an embodiment of an on-demand advertisement system 10 that includes an advertisement device 12, a user computing device 14, a business computing device 15 and a computer server 16. The advertisement device 12 may be a portable device and coupled to the user computing device 14, and the user computing device 14 may also be coupled to the computer server 16. The business computing device 15 may also be coupled to the server 16. The coupling between the advertisement device 12 and the user computing device 14 and the business computing device 15 may be a wireless connection, such as, but not limited to a Bluetooth connection, a Wi-Fi connection or the like for transmission of communication between the advertisement device 12 and the user computing device 14. The coupling between the user computing device 14 and the server 16 may be a network connection, such as through an Internet connection, wherein the user computing device 14 or the business computing device 15 may communicate with and receive communication from the server 16. Both the user computing device 14 and the business computing device 15 may include a laptop, a tablet, a smartphone, wearable devices and the like. The server 16, in some embodiments, may be a computer server or a cloud-based infrastructure architecture.

The server 16 may include a memory storing operator data including the operator identification and current location of the operator when active on the system; and advertisement data, which may further include business information including locations of each business of the business information, advertisement content associated with each business, advertisement location(s) purchased/associated with each business. The advertisement data may be updated by business at any time through the business computing device 15.

### Operator Selects Available Advertisement Opportunity

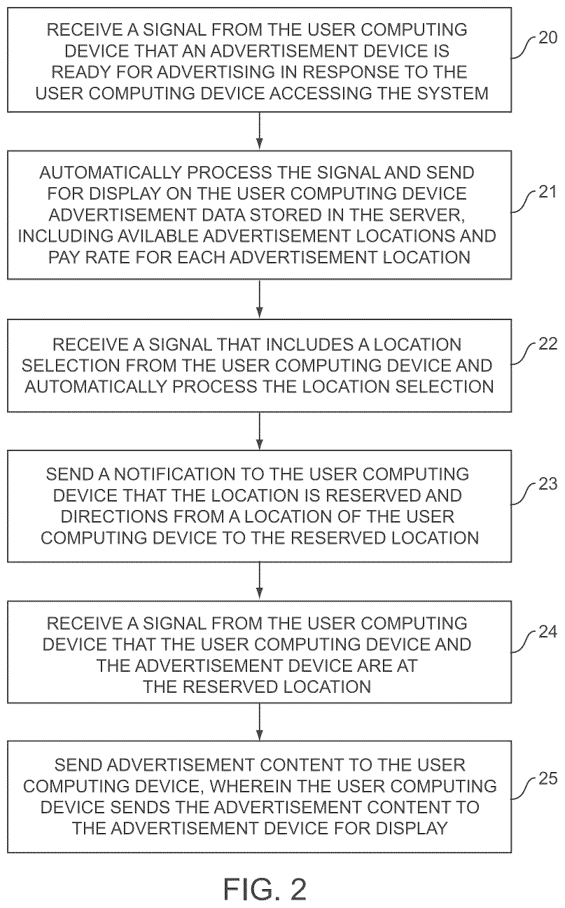

The system 10 may include use where the operator selects available advertisement opportunity from among one or more available opportunities. In accordance with this embodiment, the advertisement device 12 may be coupled to the user computing device 14, and the user computing device 14 may be coupled to the server 16. Referring to FIG. 2, the server 16 may be programmed to receive a signal from the user computing device that an advertisement device is ready for advertising in response to the user computing device accessing the system (Step 20); automatically process the signal and send for display on the user computing device advertisement data stored in the server, including available advertisement locations and pay rate for each advertisement location (Step 21); receive a signal that includes a location selection from the user computing device and automatically process the location selection (Step 22); send a notification to the user computing device that the location is reserved and directions from a location of the user computing device to the reserved location (Step 23); receive a signal from the user computing device that the user computing device and the advertisement device are at the reserved location (Step 24); and send advertisement content to the user computing device, wherein the user computing device sends the advertisement content to the advertisement device for display (Step 25). At this point, the user then holds or otherwise presents the advertisement device to passing public at the location reserved.

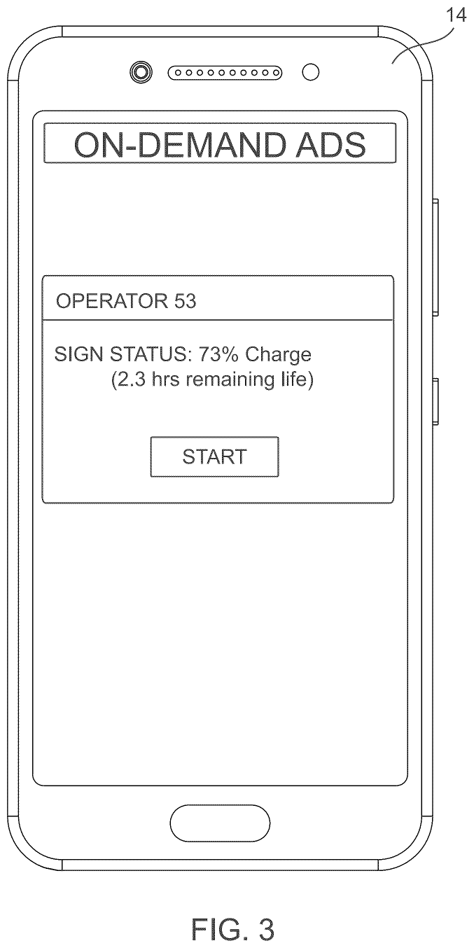

To further illustrate the operation of an embodiment of the on-demand advertisement system 10, FIGS. 3-8 are provided. The user may operate an on-demand advertisement app on the user computing device 14 to access the system 10 as shown in FIG. 3. The user computing device 14 may include a user interface as shown in FIG. 3 to access the system 10. The user may see the status of the advertisement device (sign) 12 and may select to start the advertisement session by selecting a start button. Once the user selects the start button, the user computing device 14 sends a signal to the server 16 that the user computing device 14 and the advertisement device 12 is ready for advertising.

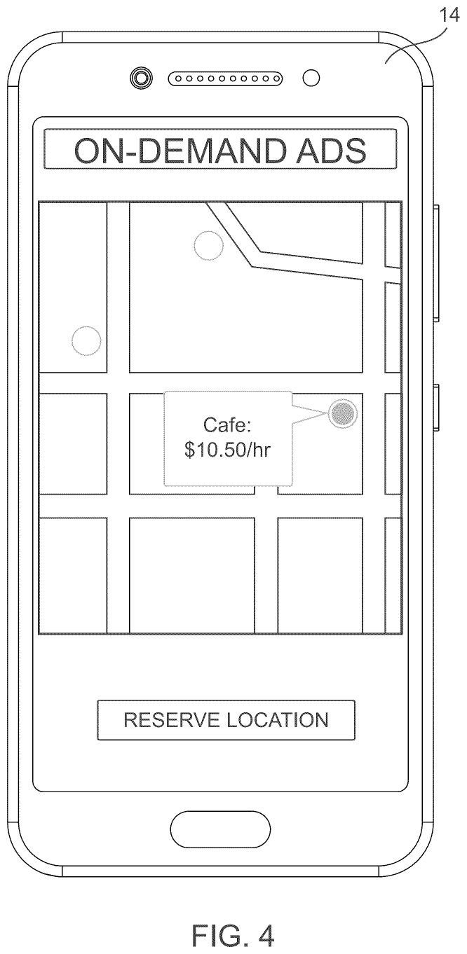

In response to processing the signal, the server 16 sends for display on the user computing device 14 a map with various locations available for advertising as shown in FIG. 4. The user may select a location, wherein the user interface depicts the company associated with the location and a pay rate for advertising in that location. The user may select a reserve location button to reserve the location for advertisement. The selection of the button to reserve the location results in a signal being sent to the server 16 indicating the request to reserve the location.

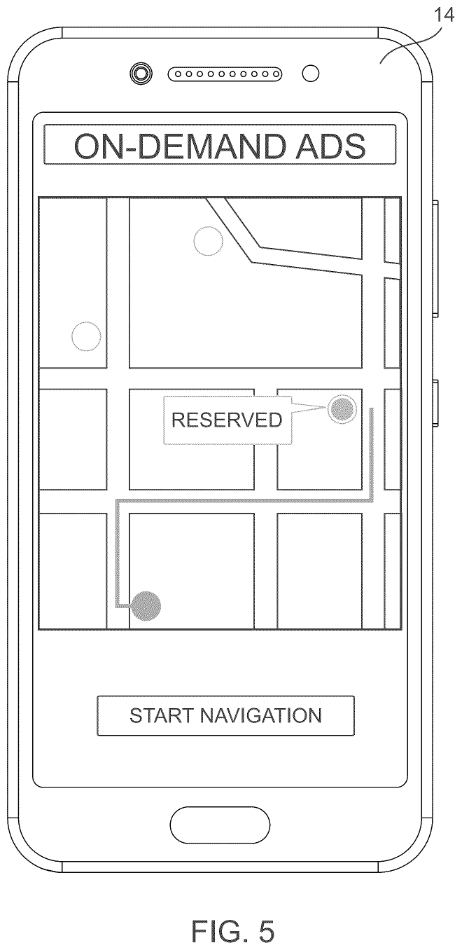

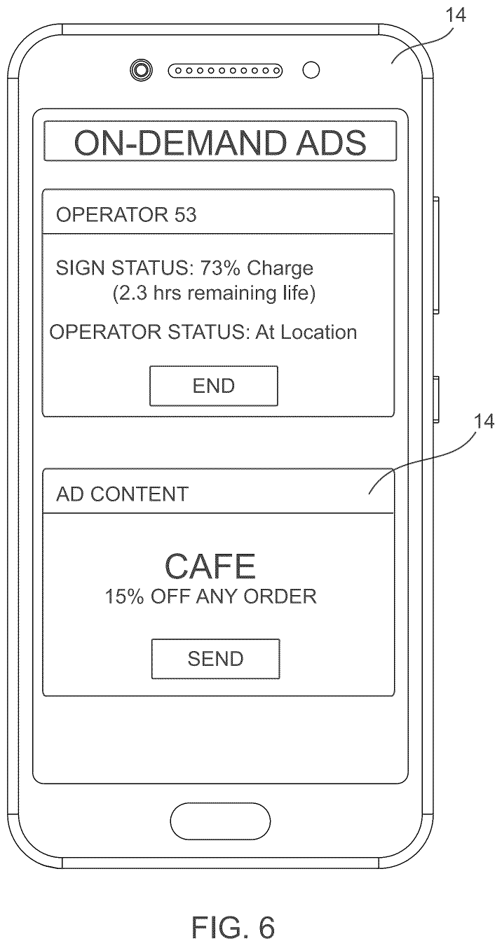

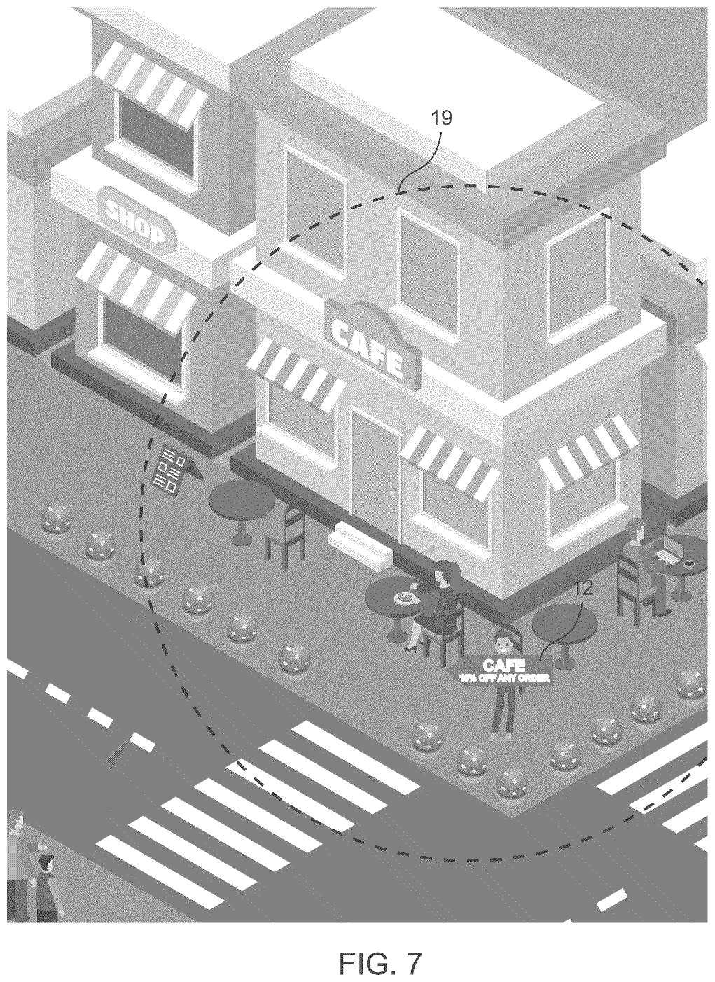

The server 16 may send information to the user computing device 14 a map for navigation to the reserved location and may also display a notification that the location is indeed reserved, as shown in FIG. 5. The user may navigate to the location for advertising. The system may establish an advertisement area, geofence or the like around the location (see geofence 20 in FIG. 7). The user computing device 14 may send its location and connection to the advertisement device 12 to the server 16, thereby allowing the server 16 to determine if the user computing device 14 and the advertisement device 12 are within the advertisement area 19. Once this determination is made, the server 16 may send for display on the user computing device 14 a user interface that includes the advertisement content 30 of the business associated with the reserved location as shown in FIG. 6. The user may select the send button on the user interface to send the advertisement content to the advertisement device 12. This will continue to function and operate as shown so long as the user computing device 14 is within the advertisement area 19 and in communication with the advertisement device 12. The system 10 may also operate to determine how long the user was actually advertising by receiving the status of the advertisement device 12 and the user computing device 14 and calculates the amount of time that both were in operation within the advertisement area 19, thereby operating like a time clock for work purposes. The system may then pay the user based on the rate and time that the user was engaged in presenting the advertisements within the advertisement area at the agreed upon rate when the user selected the location. This allows the business to only pay for the amount of time the user is actually engaged in the active advertising of the business' advertisement content and further gives control over the amount of time the user is willing to advertise.

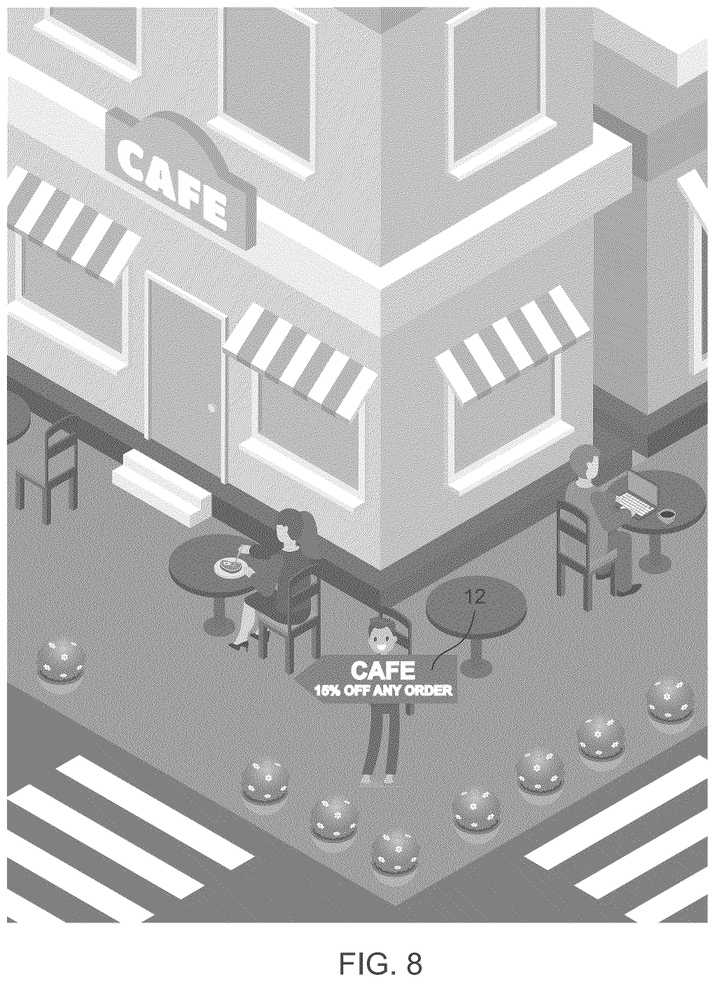

Once the advertisement content is sent to the advertisement device 12, as shown in FIGS. 7 and 8, the user may hold or otherwise present the advertisement device to the public that passes by. The advertisement content 30 may be adjusted by the business and is not static. In fact, in some embodiments, the business may adjust the advertisement content during the time the advertisement device 12 is within the advertising area 20 and the advertisement content 30 on the advertisement device 12 will be adjusted accordingly. As shown in FIG. 7, the advertisement device 12 may be a sign that is within the advertisement area 19 and displays an advertisement for the business nearby (See FIG. 8). As described above, the system 10 provides for an on-demand advertisements because the businesses can supply the advertisement on demand and users can select to advertise at any location. Additionally, advertisements can be geo location based wherein the location of the advertisement device may be determined by either a GPS device in the advertisement device 12 or may be determined by a location device in the user computing device 14 carried by the user and coupled to the advertisement device 12.

In embodiments, the advertisement device 12 may be a sign, that has a digital screen, flexible digital screen, LED screen, OLED screen or other type of display with a controller that connects and communicates with a user computing device 14. This sign that is a screen can supply advertisements to the passing public as sent by the user computing device 14. Because it is a screen, the advertisement content 30 may be text, graphics/images, video or combinations thereof. The advertisement content may be dynamic and change during the advertisement session allowing for variation and visual changes that draw attention to the advertisement device without the need for flipping, twirling or otherwise move the sign to draw attention to the passing public. This allows the public to actually see what is advertised on the sign instead of just viewing a flipping sign.

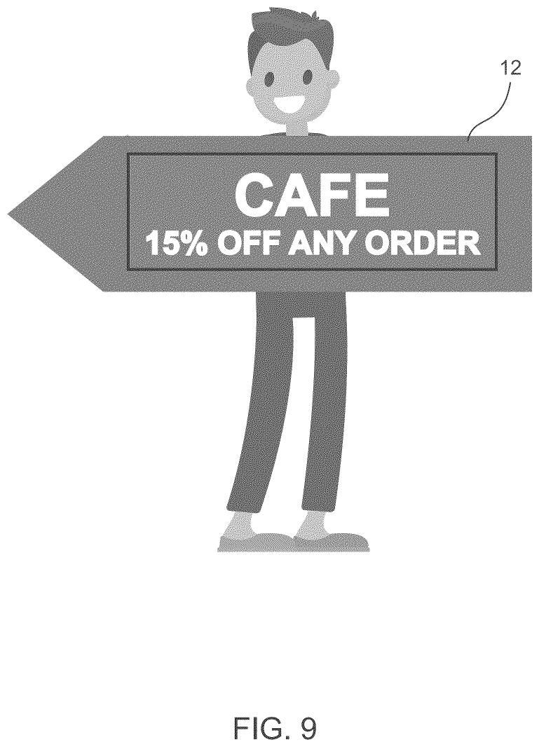

While it has been described that the advertisement device is an entire screen or the like, FIG. 9 depicts another embodiment wherein a screen is embedded within a sign, such as a screen within an arrow sign as shown. The sign that receives the screen may be formed of other material, such as a foam material that will be light and supply a barrier to damage of the screen by a drop or the like. The screen may include a controller that allows the sign to communicate with the user computing device 14. The screen can be any type of screen that can operate as an advertisement device.

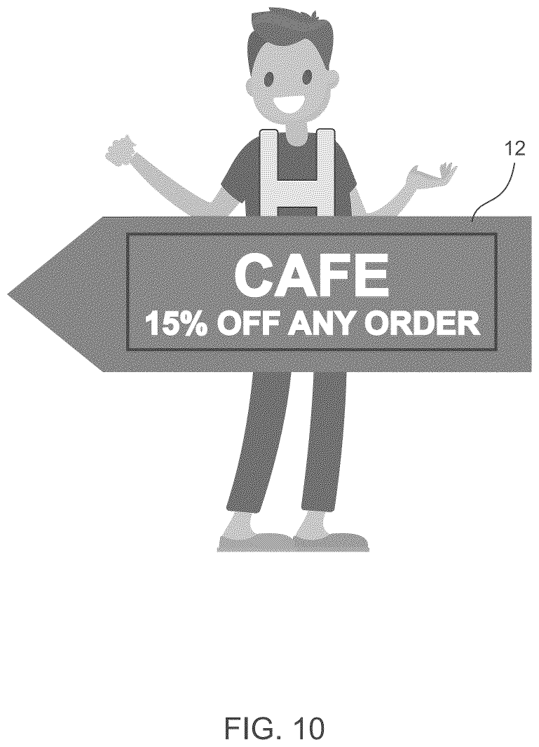

Additionally, in some instances the carrying of an advertisement device 12 may be difficult as time passes. For example, an advertisement device 12 that is a sign with an embedded screen may be heavy and hard to hold for an extended period of time. The user's arms may tire or otherwise the bulk of the advertisement device may make holding it for prolonged periods of time difficult. As shown in FIG. 10, the advertisement device 12 may also include a shoulder harness coupled to the advertisement device 12. The shoulder harness allows the weight of the advertisement device 12 to be born by legs and other muscles of the user instead of just the arms.

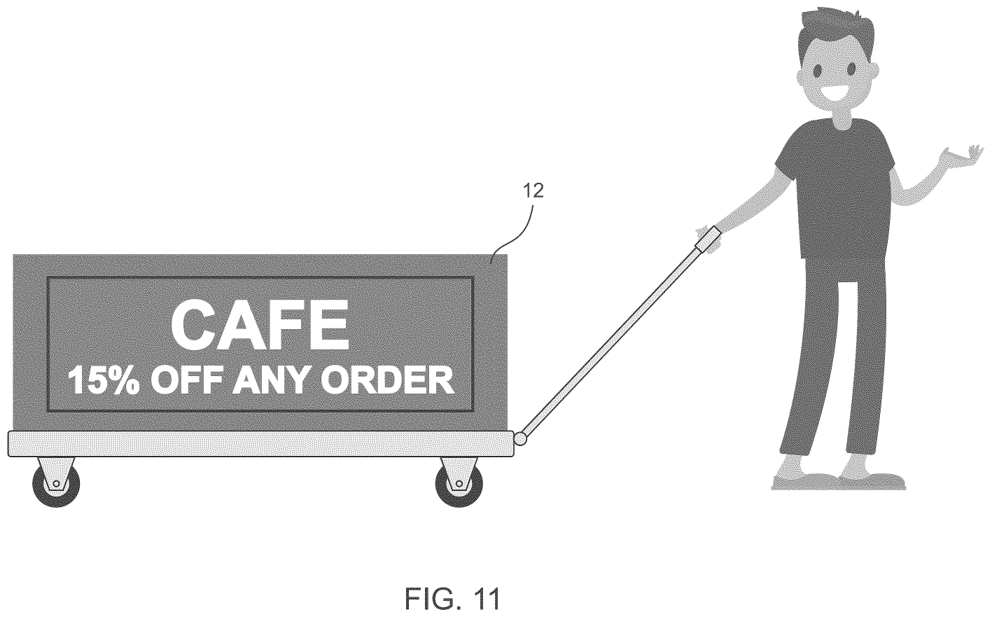

Further still, in some instances, the advertisement device 12 may be heavy or may also be to large to hold. This makes it more difficult to move around and to transport the sign to the reserved location to begin displaying an advertisement. In embodiments, as shown in FIG. 11, the advertisement device 12 may include wheels or casters in order to roll the sign to the reserved location or roll it within the advertisement area in order to face the sign to the more dense traffic of passing people. To better maneuver and control the advertisement device with wheels or casters, the advertisement device 12 may include a handle that the user can use to pull, push and steer the advertisement device 12.

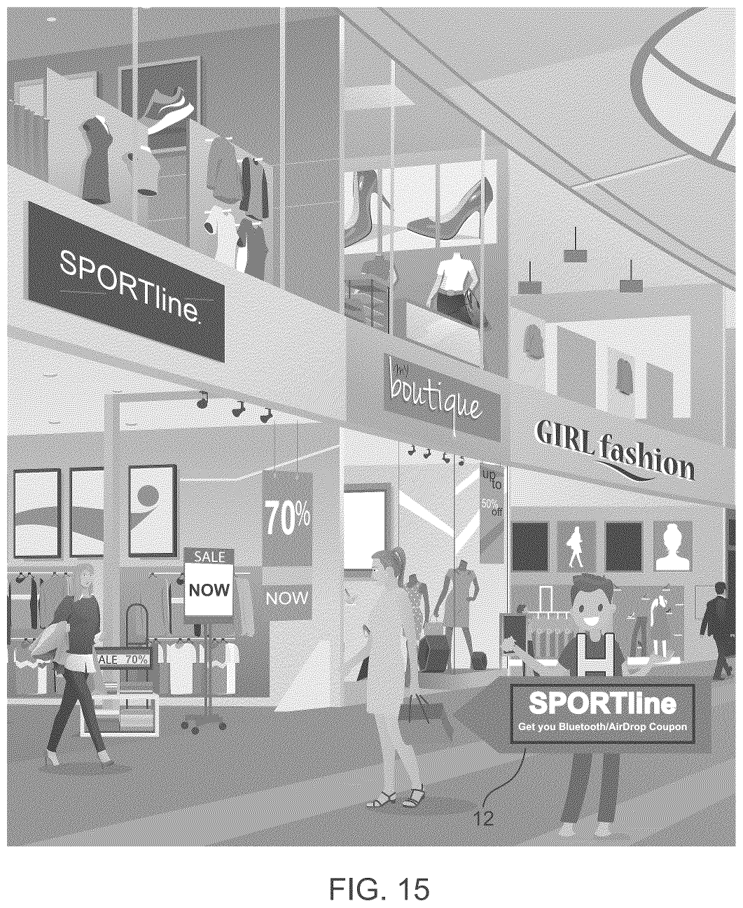

Further still, referring to FIG. 15, the advertisement device 12 may display an advertisement for a coupon. The controller of the advertisement device 12 may be programmed to execute instructions to send a coupon to users passing by that engage with the system to accept the coupon on behalf of the business that has engaged the system for advertising within that advertisement area/location. Optionally, the user computing device 14 coupled to the advertisement device 12 may receive instructions from the server to execute for sending a coupon to others passing by, wherein the coupon is for the business that has engaged the system 10 for advertisement in that location. The coupon may be a photo of a coupon with or without a bar code or the like for the business. Consumers passing by may take a photo of the coupon or the display may have a scannable code that once scanned directs the consumer's device to a digital coupon for the business. In some embodiments, the coupon is sent through wireless communications such as by Bluetooth communication or other wireless communication protocols. This provides real time coupons to be distributed in addition to the advertisement and to do so electronically and eliminating the need of the operators to hand paper coupons to the passing public.

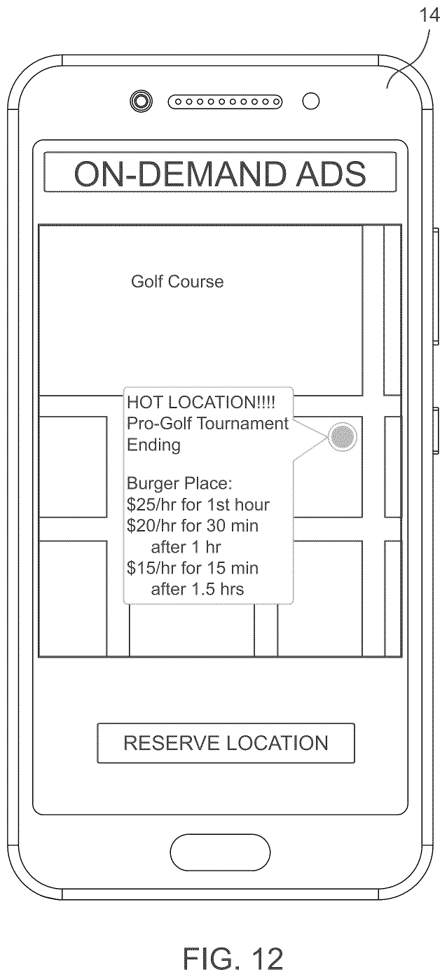

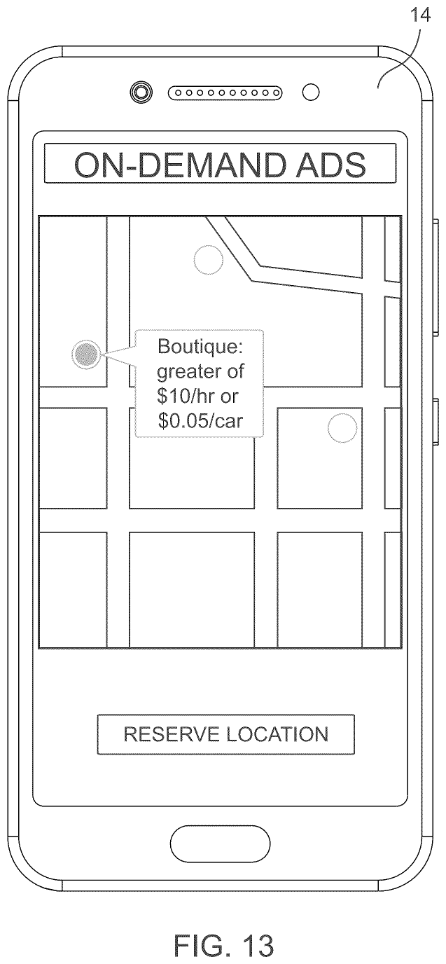

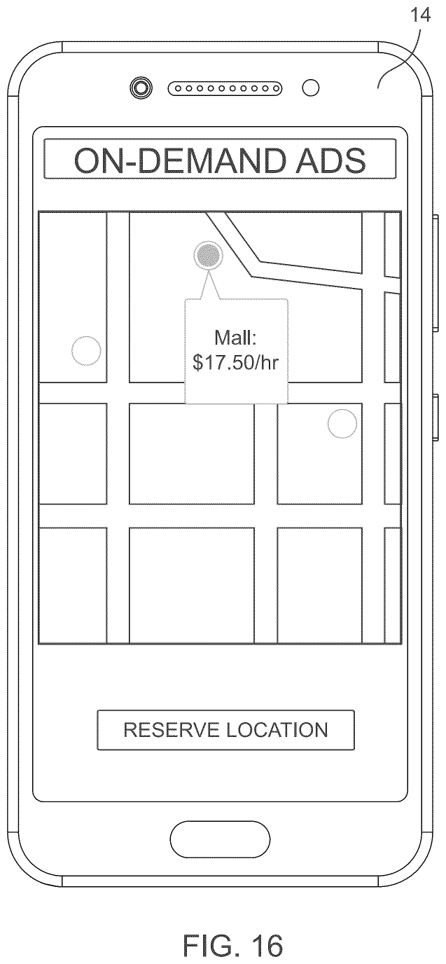

Referring again to the drawings, as discussed in FIG. 4, in response to processing the signal, the server 16 sends for display on the user computing device 14 a map with various locations available for advertising as shown in FIGS. 12, 13 and 16. The user may select a location, wherein the user interface depicts the company associated with the location and a pay rate for advertising in that location. In some embodiments, as shown in FIG. 12, the pay rate may have a varying scale based on the amount of time in the location and further based on whether there is a hot location meaning a location with a lot of traffic or passing public. In FIG. 12 the location is at the exit of a golf course after a pro golf tournament is ending and provides for varying rates to advertise at that location. Another embodiment as shown in FIG. 13 includes varying rate that is either hourly or on a per vehicle basis allowing the operator to earn more money if the traffic is high. This allows for businesses to engage operators during high traffic times and compensates the user/operator accordingly the user may select a reserve location button to reserve the location for advertisement. The selection of the button to reserve the location results in a signal being sent to the server 16 indicating the request to reserve the location. In yet another embodiment, as shown in FIG. 16, the location may be one with multiple businesses (such as, but not limited to a mall, a shopping plaza, a festival or the like) that will all advertise on the system 10 at that location using an agent, such as a mall administrator or the like. There may be a single rate, as shown, or there may be variable rates for each business. Once the user gets to the location (see FIG. 15 for a mall setting) the advertisement content sent to the advertisement device 12 may rotate through the various businesses and may vary in time on each advertisement based on predetermined times selected by the business or by the agent of the collection of businesses. In some embodiments, the operator may be asked to move around and based on the location of the advertisement device 12 a different add for a different business will be displayed. There may be several ways of determining which business advertisement content to display and how long to display such content, all of which fall within the scope of this invention.

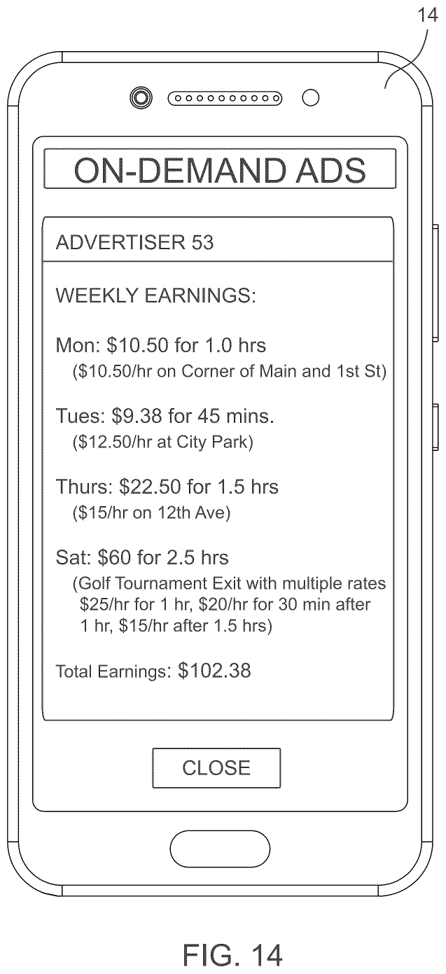

At the end of a selected period of time, such as a week, the system 10 may operate wherein the server 16 is programmed to send for display on the user computing device 14 an accounting for the weekly earnings of the operator, as depicted in FIG. 14. This can include listing the locations, pay rates, amount of time in an advertising area and total amount earned. The user/operator can then determine what is the higher paying advertising areas and locations. It will be understood that this system 10 provides the users that are operators, wherein operators are individuals who purchase or lease the advertising devices 12 and go to the locations reserved have control over the time they work, where they work and how much they earn. The system decentralizes the work force for advertising purposes allowing operators to select utilizing their time to advertise in locations near wherever the operator is currently at. This decentralization of the work force allows operators to reach the locations more efficiently and at time that they can control, such as for a second income stream, to pass the time or other reasons why a user would want to engage in advertisement using the system.

Operator Requests Bids from Businesses for Advertisement Opportunity

The system 10 may include use where the operator is at a location and requests bids from businesses, such as nearby businesses and so forth, wherein the bids may be pay rate to advertise on operators sign at operators location. In accordance with this embodiment, the advertisement device 12 may be coupled to the user computing device 14, and the user computing device 14 may be coupled to the server 16. Referring to FIG. 2, the server 16 may be programmed to receive a signal from the user computing device that an advertisement device is ready for advertising at a location in response to the user computing device accessing the system (Step 100); automatically process the signal and send for display on the a plurality of business computing devices, operator data stored in the server 16, including advertisement location of the operator and a request for advertising with the operator (Step 101); receive a signal from each of the plurality of business computing devices including a pay rate bid to engage the operator to advertise (Step 102); automatically process the signal and send for display on the user computing device each of the pay rate bids from the plurality of business computing devices (Step 103); receive a signal from the user computing device including a selection of one of the pay rate bids (Step 104); and send advertisement content to the user computing device, wherein the user computing device sends the advertisement content to the advertisement device for display (Step 105). At this point, the user then holds or otherwise presents the advertisement device to passing public at the operator's location.

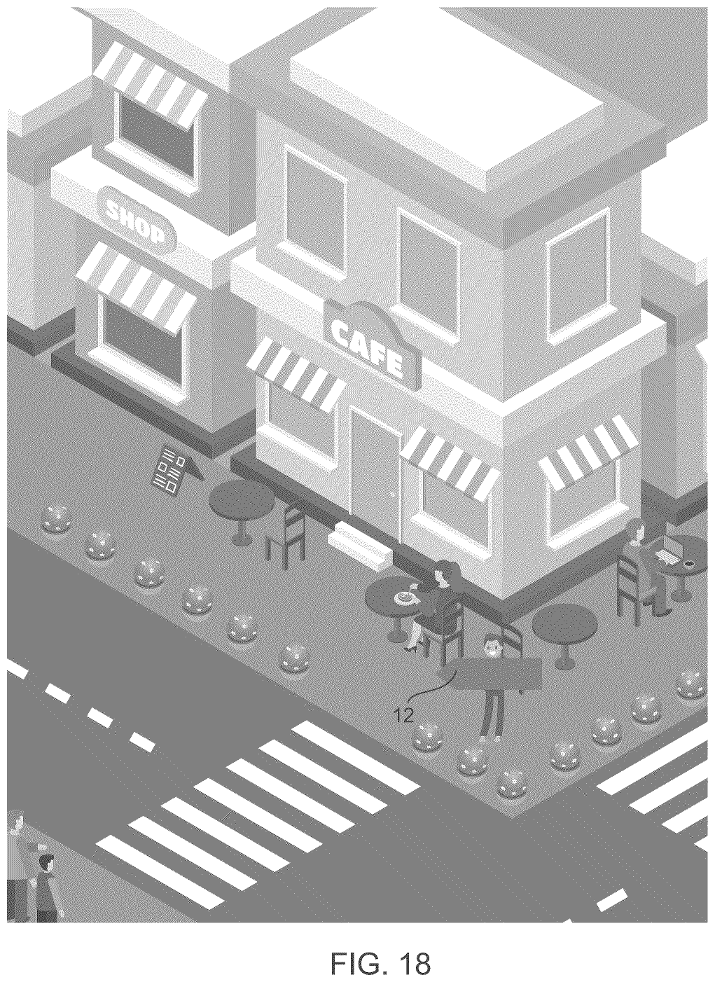

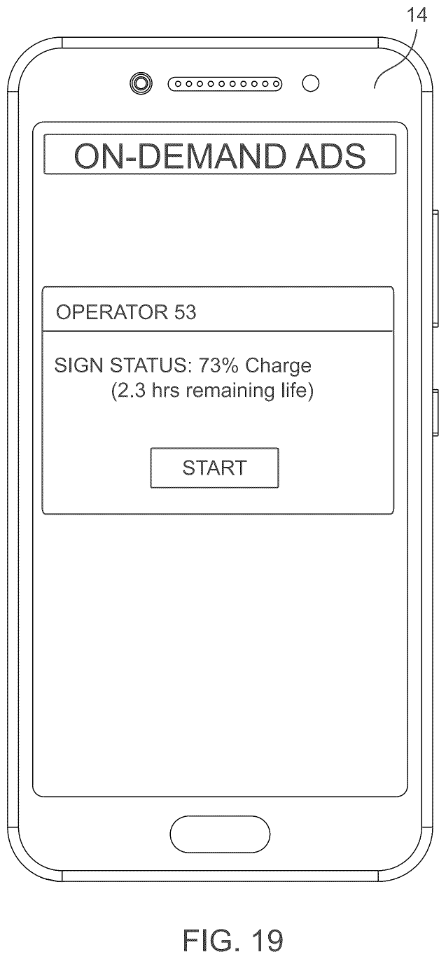

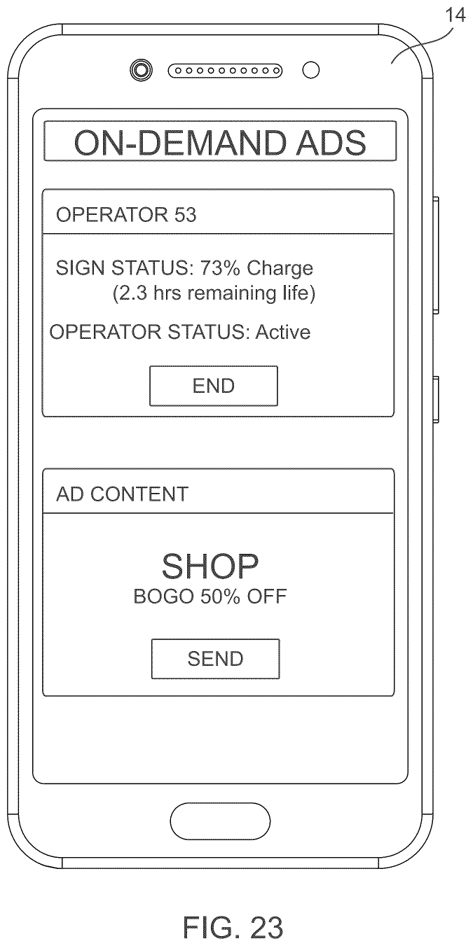

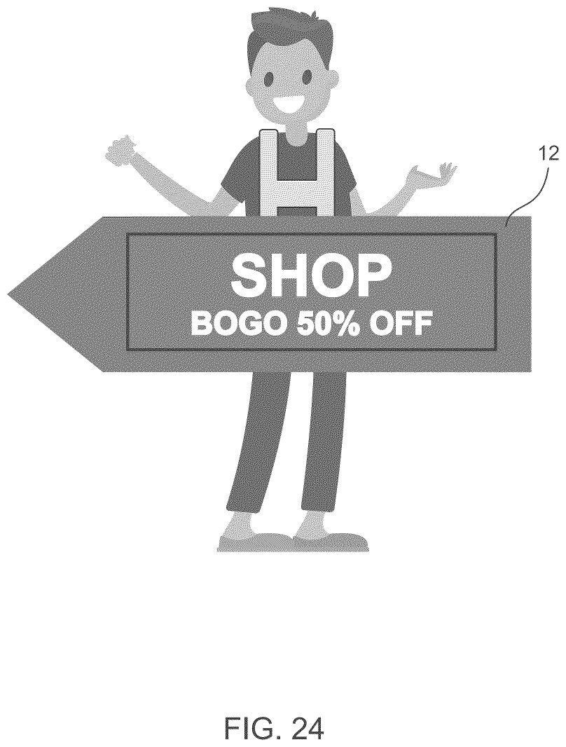

To further illustrate the operation of an embodiment of the on-demand advertisement system 10, FIGS. 18-24 are provided. The user may go to particular location, such as a street corner with an advertisement device 12, as shown in FIG. 18. The user may operate an on-demand advertisement app on the user computing device 14 to access the system 10 as shown in FIG. 19. The user computing device 14 may include a user interface as shown in FIG. 19 to access the system 10. The user may see the status of the advertisement device (sign) 12 and may select to start the advertisement session by selecting a start button. Once the user selects the start button, the user computing device 14 sends a signal to the server 16 that the user computing device 14 and the advertisement device 12 is ready for advertising.

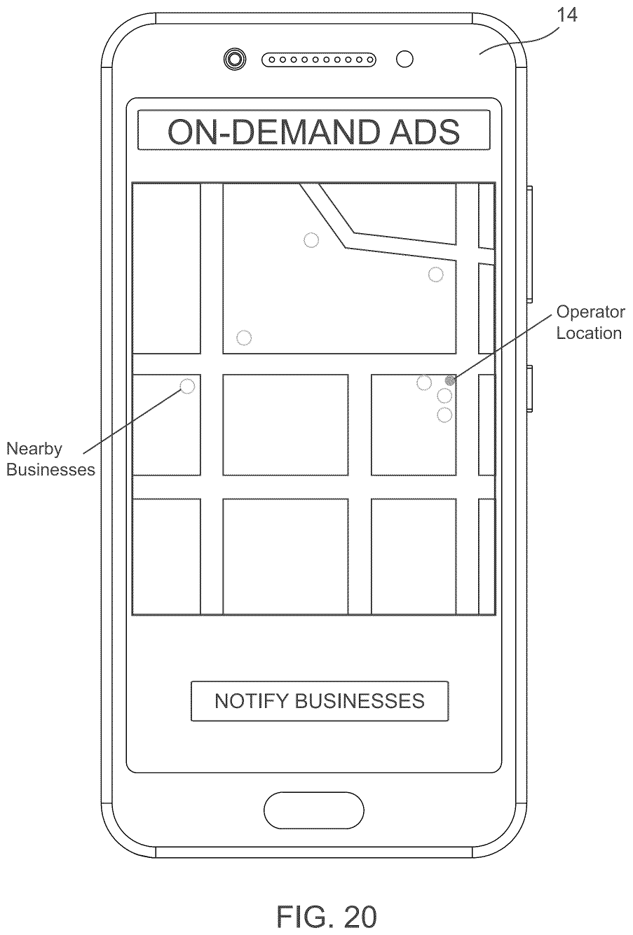

In response to processing the signal, the server 16 sends for display on the user computing device 14 a map depicting the operator's location (location of the user computing device 14) and also locations of various businesses, such as nearby businesses as shown in FIG. 20. The user may select to notify the businesses that the operator is at that particular location and ready to advertise on his or her advertisement device 12. The user may select a notify businesses button to send a request for bids from the businesses to advertise on that advertisement device 12 at that location.

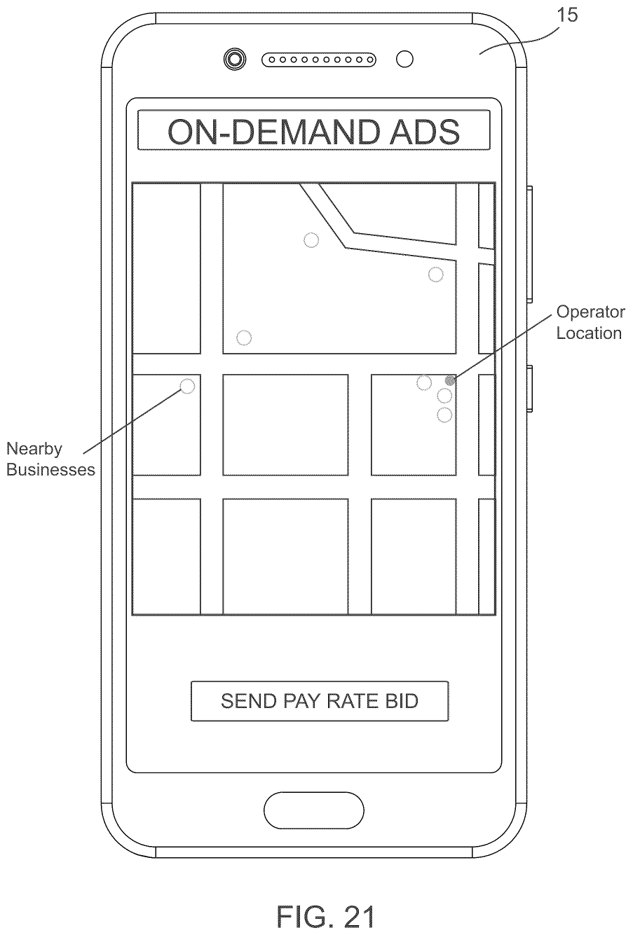

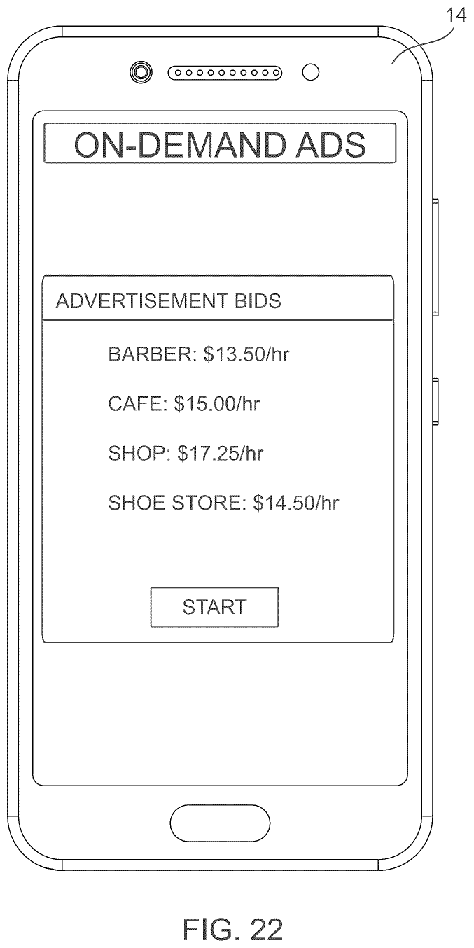

The server 16 may send the bid request to a plurality of business computing devices 14 a map showing the location of operator ready for advertisement and may also show the location of other businesses that have been sent the bid request, as shown in FIG. 21. The business may select the send pay rate bid button or the like on the interface and enter a pay rate bid and send the same to the user computing device 12 of the operator. The serve 16 may then send to the user computing device 14 of the operator all of the bids for display and selection, as shown in FIG. 22. The operator may select a bid and press the start button or the like to start advertisement for the selected business at the selected rate. Once the bid is accepted/selected, the server 16 may send for display on the user computing device 14 a user interface that include the advertisement content 30 of the business associated with the reserved location as shown in FIG. 6. The user may select the send button on the user interface to send the advertisement content to the advertisement device 12. This will continue to function an operate as shown so long as the user computing device 14 is within the advertisement area 19 and in communication with the advertisement device 12. The system 10 may also operate to determine how long the user was actually advertising by receiving the status of the advertisement device 12 and the user computing device 14 and calculates the amount of tie that both were in operation within the advertisement area 19, thereby operating like a time clock for work purposes. The system may then pay the user based on the rate and time that the user was engaged in presenting the advertisements within the advertisement area at the agreed upon rate when the user selected the location. This allows the business to only pay for the amount of time the user is actually engaged in the active advertising of the business' advertisement content and further gives control over the amount of time the user is willing to advertise. It will be understood that the advertisement device 12 includes all of the possible features as described above.

The on-demand system has many advantages over existing advertisement systems. For example and without limitation, the old static sign is limited in many ways like the sign is made only to hold one message for life, is good only at certain locations, are static so people flip them to attract attention, is deployed by manual printing on a substrate, and sign flippers become bored standing on the same corner day after day. The on-demand system 10 provide advantages such as, but not limited to the sign can have multiple messages and never gets old, the sign can be used at any location, the sign is not static and does not need flipping to attract attention, the advertisement is deployed on the sign using technology, and the sign has multiple messages.

Because the advertisement device 12 can display advertisements of any business depending on what location the sign 12 is deployed, businesses no longer need to purchase signs that are static and stored for use by an employee or other person hired to stand on the corner and present the sign. The business can manage the advertisement content and times it wants advertisement through a computing device that can access the server and provide the business data stored therein. Additionally, the user that will be holding the sign or a “sign flipper” may use the system for a second stream of income, wherein the sign flipper can purchase an advertisement device 12 such as a sign with a screen and then use his or her smartphone to choose when and where to work. The businesses can set rates for sign flippers and the sign flippers can choose locations based on not just proximity to the sign flipper but based on the rate of pay. Further still, the system 10 may also provide variable pricing for advertising demand to locate at certain locations and time at location. For example, after an event the traffic is high in certain areas and the rate to advertise in those area may be much higher than the same area during normal traffic days and times. This system 10 allows for sign flippers to work for multiple companies and to do so on an on-demand basis when he or she has time and further allows businesses to benefit from such a system to provide updated and dynamic advertising content, such as adding a sale for a specific period of time even after the sign flipper has been in the location with advertisements already on his or her sign.

Embodiments may be available on or through the internet, such as through domain names reserved and owned by Applicant that include gpsflipper.com, gpsmysign.com, smartsigncompany.com or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An on-demand advertisement system comprising:
an advertisement device;
a user computing device coupled to the advertisement device; and
a server having a memory storing advertisement data, wherein the user computing device is coupled to the server through a connection established by an app operating on the user computing device, and wherein the server is programmed to:
receive a signal from the user computing device that the advertisement device is ready for advertising in response to the user computing device accessing the system;
automatically process the signal and send for display on the user computing device the advertisement data stored in the server, comprising available advertisement locations and pay rate for each of the available advertisement locations, wherein each available advertising location comprises a geofence around the advertisement location;
receive a signal comprising a location selection from the user computing device and automatically process the location selection;
send a notification to the user computing device that the location selection is reserved and directions from a location of the user computing device to the reserved location selection;
receive a signal from the user computing device that the user computing device and the advertisement device are within the geofence of the reserved location selection;
send advertisement content to the user computing device, wherein the user computing device sends the advertisement content to the advertisement device for display after confirming the user computing device and the advertisement device are within the geofence of the reserved location selection;
continuing to display the advertisement content on the advertisement device so long as the user computing device and advertisement device are within the geofence; and
calculate an amount of time that the user computing device and advertisement device with within the geofence to determine a payment amount to the user based on the pay rate and the calculated amount of time.

2. The system of claim 1, wherein the advertisement device is a sign having a digital screen.

3. The system of claim 2, wherein the digital screen comprises a flexible digital screen, an LED screen, or an OLED screen.

4. The system of claim 3, wherein the advertisement device further comprises a controller that connects and communicates with the user computing device.

5. The system of claim 3, wherein the digital screen is embedded within the sign, wherein the sign is formed of a material that is light and supplies a barrier to damage of the screen.

6. An on-demand advertisement system comprising:
an advertisement device;
a user computing device coupled to the advertisement device; and
a server having a memory storing advertisement data, wherein the user computing device is coupled to the server through a connection established by an app operating on the user computing device, and wherein the server is programmed to:
receive a signal from the user computing device that the advertisement device is ready for advertising at a location in response to the user computing device accessing the system, wherein the location comprises a geofence establishing a perimeter of the location;
automatically process the signal and send for display on a plurality of business computing devices, operator data stored in the server, including the geofenced advertisement location of an operator and a request for advertising with the operator;
receive a signal from each of the plurality of business computing devices comprising a pay rate bid to engage the operator to advertise;
automatically process the signal and send for display on the user computing device each of the pay rate bids from the plurality of business computing devices;
receive a signal from the user computing device comprising a selection of one of the pay rate bids;
send advertisement content to the user computing device, wherein the user computing device sends the advertisement content to the advertisement device for display after confirming the user computing device and the advertisement device are within the geofence of the location;
continuing to display the advertisement content on the advertisement device so long as the user computing device and advertisement device are within the geofence; and
calculate an amount of time that the user computing device and advertisement device with within the geofence to determine a payment amount to the user based on the pay rate bid and the calculated amount of time.

7. The system of claim 6, wherein the advertisement device is a sign having a digital screen.

8. The system of claim 7, wherein the digital screen comprises a flexible digital screen, an LED screen, or an OLED screen.

9. The system of claim 8, wherein the advertisement device further comprises a controller that connects and communicates with the user computing device.

10. The system of claim 8, wherein the digital screen is embedded within the sign, wherein the sign is formed of a material that is light and supplies a barrier to damage of the screen.
